(19) United States
(12) Patent Application Publication
(10) Pub. No.: US 2020/0394802 A1
(43) Pub. Date: Dec. 17, 2020

(54) REAL-TIME OBJECT DETECTION METHOD FOR MULTIPLE CAMERA IMAGES USING FRAME SEGMENTATION AND INTELLIGENT DETECTION POOL

(71) Applicant: 4IND CO., LTD., Gumi-si (KR)

(72) Inventors: Chae Soo Lee, Daegu (KR); Man Sang Ryu, Gyeongju-si (KR)

(21) Appl. No.: 16/890,277

(22) Filed: Jun. 2, 2020

(30) Foreign Application Priority Data
Jun. 17, 2019 (KR) 10-2019-0071357

(51) Int. Cl. G06T 7/174; G06T 7/194

(52) U.S. Cl. CPC G06T 7/174; G06T 2207/30261; G06T 2207/10016; G06T 7/194

(57) ABSTRACT

Disclosed herein is an object detection method for detecting objects in real time from images photographed by a plurality of cameras via an intelligent machine vision apparatus. The object detection method includes: a first step of receiving images from the cameras; a second step of detecting objects from the received images; a third step of determining the types of objects based on results of the detection performed at the second step; and a fourth step of displaying the results of the types of objects determined at the third step.

### CROSS-REFERENCE TO RELATED APPLICATION

This application claims the benefit of Korean Patent Application No. 10-2019-0071357 filed on Jun. 17, 2019, which is hereby incorporated by reference herein in its entirety.

### BACKGROUND

### 1. Technical Field

The present invention relates generally to a result of research conducted as the “Startup Growth-Technology Development Project” sponsored by the Korean Ministry of SEMs and Startups, and more particularly to a method of detecting objects, such as humans and vehicles, from multiple camera images in real time by using frame segmentation and an intelligent detection pool.

### 2. Description of the Related Art

Closed-circuit television (CCTV) is installed and used in apartments and alleys. As CCTV is used in various places, the development of efficient monitoring technology is in progress.

Recently, there have been actively developed intelligent video surveillance (IVS) systems that automatically detect anomalous behavior and then transmit an alert to an administrator when a machine-learned object is detected from an image by analyzing the information of the image.

IVS systems perform an image preprocessing step, a background region separation step, an object identification step, an object tracking step, and an event detection step of detecting events based on predefined rules.

Most of the currently developed IVS systems detect objects in a current frame via a method of obtaining the difference by comparing a background frame with the current frame by using a background difference technique. Such IVS systems can consistently detect an arbitrary object by generating a reference background image.

However, such IVS systems have a problem in that it is impossible to prevent a behavior from expanding into a significant accident because it cannot classify the detected behavior of an object and detect an accident based on a specific behavior.

Furthermore, detecting a moving object refers to finding a foreground object different from a background in an input image, and is a process necessary for various image processing applications such as intelligent video surveillance, human-computer interaction (HCI), and object-based image compression. For example, in IVS, the analysis of the behavior of an object of interest is required. It is well known that an object of interest is derived through the detection of a moving object, and the performance of IVS depends on how rapidly and accurately a moving object can be detected.

Meanwhile, a conventional moving object detection algorithm using morphology operation requires a considerable computational load, and is thus difficult to use in a multi-channel video surveillance application and in the real-time application implementation of a single channel in an embedded system. The detection of a moving object is subjected to procedures such as “foreground mask extraction, foreground mask correction, and blob splitting.”

A foreground mask represents extracted foreground pixels. For accurate object extraction, it is necessary to perform the foreground mask correction step of correcting what is incorrectly extracted or not extracted, and morphological operation, such as opening/closing, is normally performed as a preprocessing step.

Meanwhile, since the foreground mask may include a plurality of blobs, it is necessary to identify and divide these blobs, which is processed using a connected component labeling algorithm. A blob refers to a set of connected foreground pixels. Thereafter, minimum square areas including respective divided blobs are calculated, and these minimum square areas are detected as object areas.

Meanwhile, the computational load of the morphology operation that is used in the foreground mask collection process is heavy. Furthermore, the processing method of the morphology operation is different from a method used in a connected component labeling processing routine, and thus it is difficult to simultaneously process both the morphology operation and the connected component labeling processing routine. Accordingly, after the foreground mask collection process based on the morphology operation has been processed, the connected component labeling process is performed. In other words, the morphology operation itself requires a heavy computational load and foreground mask collection and connected component labeling are sequentially processed, and thus a conventional method of detecting a moving object using morphology operation takes much time to perform.

### Prior Art Documents

### Patent Documents

(Patent Document 1) KR 10-1980551 B1

(Patent Document 2) KR 10-2011-0009761 A

### SUMMARY

The present invention has been conceived to overcome the above-described problems, and an object of the present invention is to provide a real-time object detection method for multiple camera images using frame segmentation and an intelligent detection pool, in which, in order to overcome processing delay occurring in a method of simultaneously processing multiple images based on a Python-based Global Interpreter Lock (GIL) scheme, image frames are fetched on a per-block basis, the fetched frames are segmented, similar adjacent frames are removed and a successive object detection method is applied.

In order to accomplish the above object, the present invention provides an object detection method for detecting objects in real time from images photographed by a plurality of cameras via an intelligent machine vision apparatus, the real-time object detection method including: a first step of receiving images from the cameras; a second step of detecting objects from the received images; a third step of determining the types of objects based on results of the detection performed at the second step; and a fourth step of displaying the results of the types of objects determined at the third step.

### BRIEF DESCRIPTION OF THE DRAWINGS

The above and other objects, features, and advantages of the present invention will be more clearly understood from the following detailed description taken in conjunction with the accompanying drawings, in which:

FIG. 1 is a flowchart of a real-time object detection method for multiple camera images using frame segmentation and an intelligent detection pool according to the present invention;

FIG. 2 shows a bottleneck and delayed processing phenomenon attributable to GIL, which is a disadvantage of the conventional Python scheme;

FIG. 3 is a flowchart of an image frame processing method according to the present invention;

FIG. 4 is a flowchart showing the process of simultaneously processing frames fetched using a pool responsible only for detection according to the present invention;

FIG. 5 shows an apparatus for intelligent analysis and multiple video result image display for object detection according to the present invention;

FIG. 6 is a diagram of a detection software structure that is used to detect objects according to the present invention;

FIG. 7 shows a screen on which a video input stream and results according to the present invention are displayed together; and

FIG. 8 is a view illustrating an optic flow, which is one of the object detection methods that are applicable to the image frame processing method according to the present invention.

### DETAILED DESCRIPTION

Although the present invention has been described via embodiments with reference to the accompanying drawings, this is intended to help the easy understanding of the present invention, and the scope of the present invention is not limited to the above embodiments.

When a part is described as “including” a specific component throughout the specification, this means that the part may further include another component instead of excluding another component, unless specifically stated to the contrary. Furthermore, each of the terms such as “ . . . unit” and “module” described in the specification refers to a unit that processes at least one function or operation, which may be implemented in hardware, software, or a combination of hardware and software.

Throughout the specification, when a part is described as being connected to another part, this includes not only a case where they are directly connected to each other but also a case where they are electrically connected to each other with another element interposed therebetween.

In the present specification, when one component “transmits” data or a signal to another component, this means that the former component may directly transmit the data or signal to the other component and also means that the former component may transmit the data or signal to the other component through at least one third component.

Furthermore, in the present specification, the module may mean a functional and structural combination of hardware for performing the technical spirit of the present invention and software for driving the hardware. For example, it may be easily inferred by those skilled in the art that the module may mean a logical unit of a predetermined code and a hardware resource for performing the predetermined code, and does not necessarily means a physically connected code or one type of hardware.

Prior to the following description, it is noted that a number of aspects and embodiments will be described below and these are merely illustrative but not limiting.

After reading this specification, those skilled in the art will appreciate that other aspects and examples may be made without departing from the scope of the invention.

Before addressing the details of the embodiments described below, some terms will be defined or clarified.

An intelligent machine vision apparatus refers to an apparatus that automatically detects the types of objects by analyzing objects, such as humans, vehicles or the like, which could not be recognized, via software and then provides notification of the types of objects.

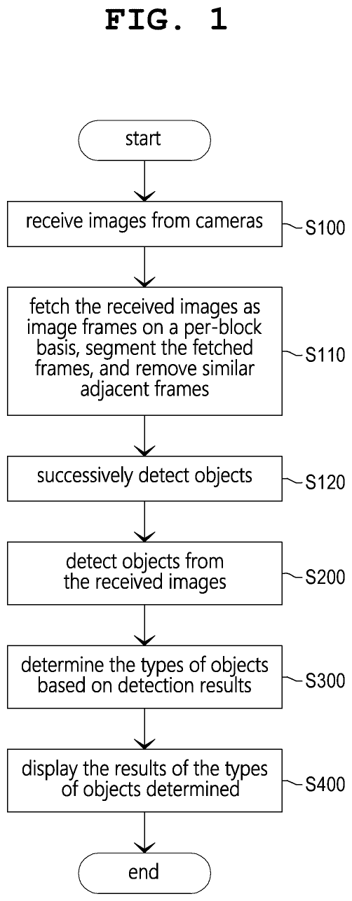

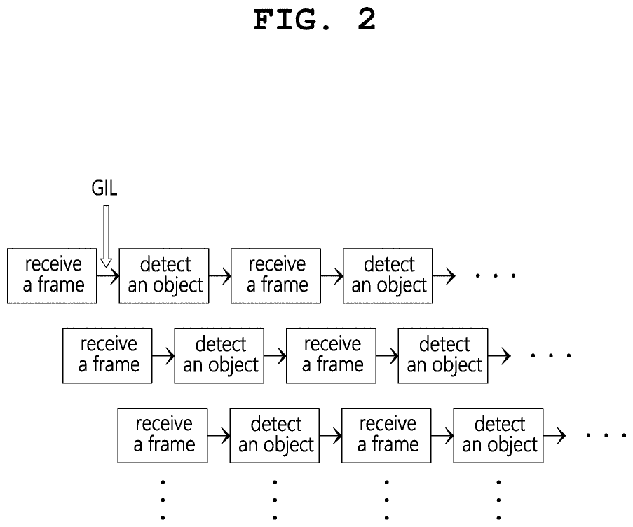

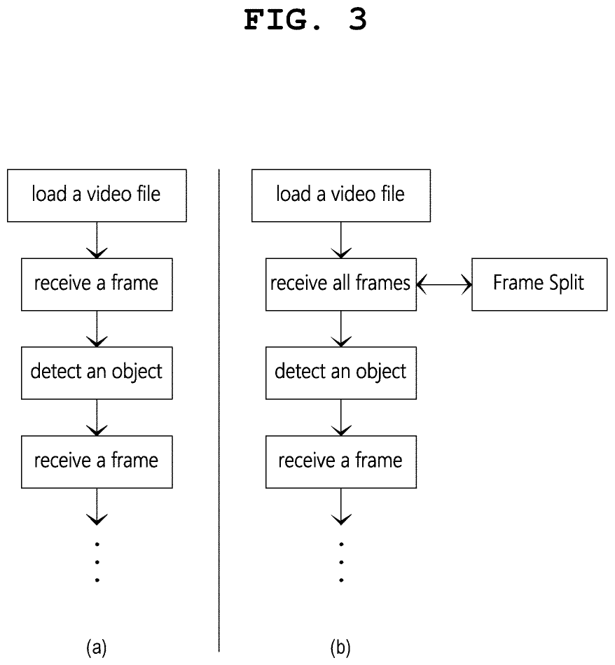

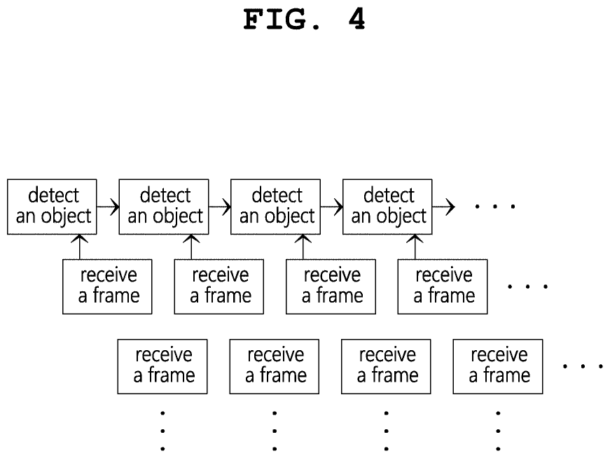

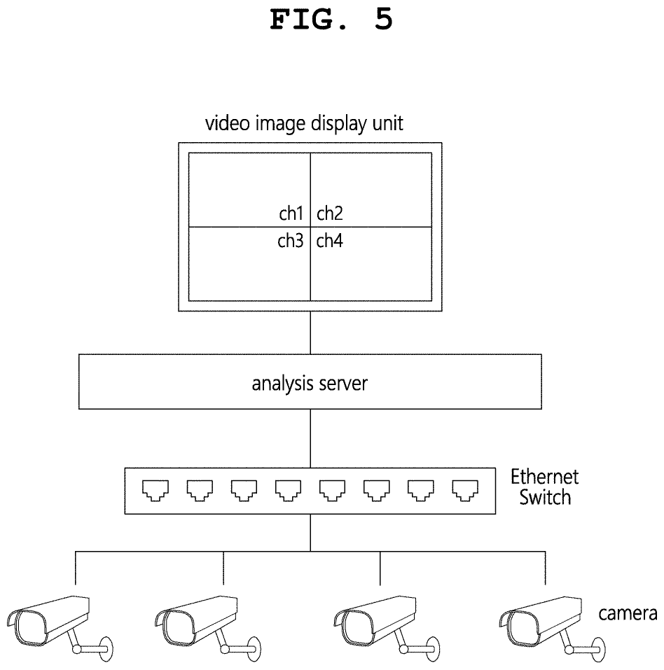

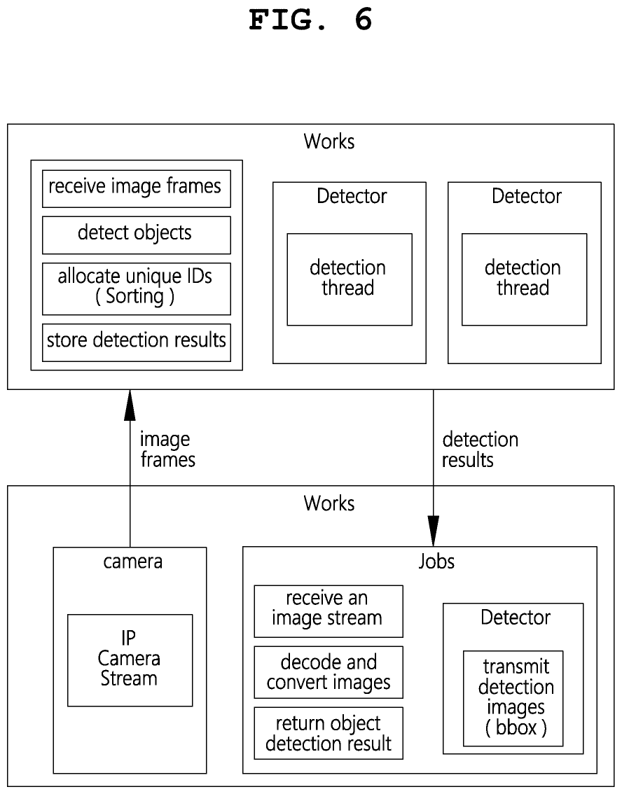

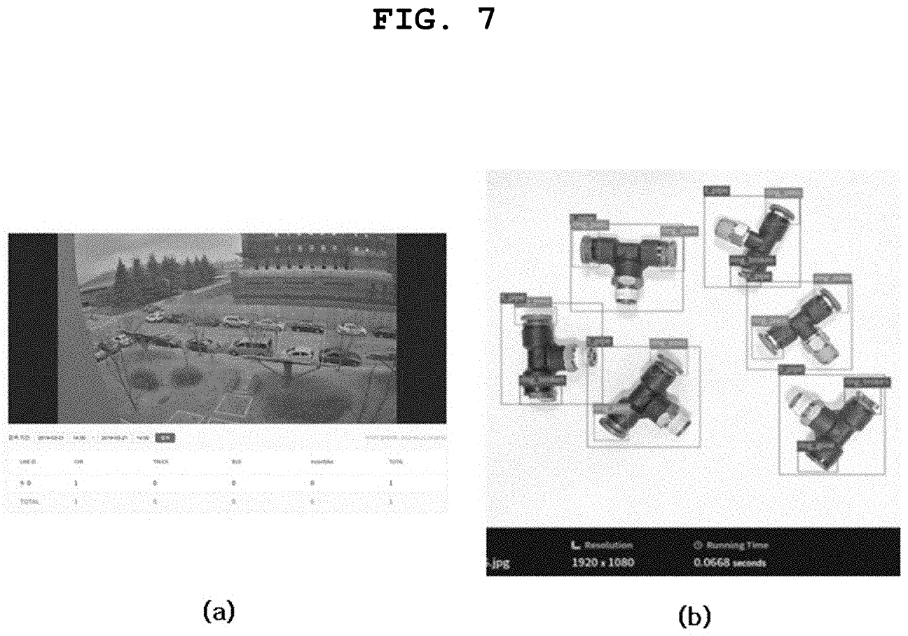

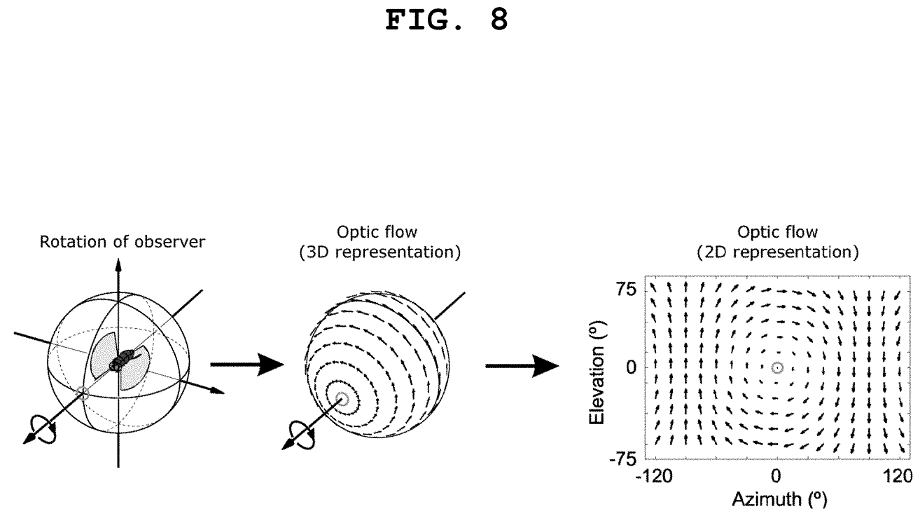

FIG. 1 is a flowchart of a real-time object detection method for multiple camera images using frame segmentation and an intelligent detection pool according to the present invention, FIG. 2 shows a bottleneck and delayed processing phenomenon attributable to GIL, which is a disadvantage of the conventional Python scheme, FIG. 3 is a flowchart of an image frame processing method according to the present invention, FIG. 4 is a flowchart showing the process of simultaneously processing frames fetched using a pool responsible only for detection according to the present invention, FIG. 5 shows an apparatus for intelligent analysis and multiple video result image display for object detection according to the present invention, FIG. 6 is a diagram of a detection software structure that is used to detect objects according to the present invention, FIG. 7 shows a screen on which a video input stream and results according to the present invention are displayed together, and FIG. 8 is a view illustrating an optic flow, which is one of the object detection methods that are applicable to the image frame processing method according to the present invention.

An object detection method for detecting objects in real time from images photographed by a plurality of cameras via an intelligent machine vision apparatus according to the present invention includes: step S100 of receiving images from the cameras; step S200 of detecting objects from the received images; step S300 of determining the types of objects based on results of the detection performed at step S200; and step S400 of displaying the results of the types of objects determined at step S300.

The object detection method may further include, after step S100, step S110 of fetching the received images as image frames on a per-block basis, segmenting the fetched frames, and removing similar adjacent frames.

Furthermore, the object detection method may further include, after step S110, step S120 of successively detecting objects.

Furthermore, the intelligent machine vision apparatus includes an intelligent detection unit configured to receive images photographed by a plurality of cameras and to determine the types of objects and a transmission unit configured to transmit results of the determination, performed by the intelligent detection unit, to a client.

Furthermore, the intelligent machine vision apparatus may include the function of removing adjacent frames after receiving and segmenting image frames, the function of allocating unique IDs to detected objects, the function of storing detection results, and the function of detecting a plurality of objects via a pool responsible only for detection.

Next, a real-time object detection method for multiple camera images using frame segmentation and an intelligent detection pool according to the present invention will be described in detail with reference to FIGS. 1 to 8. The following description will be given via an embodiment in which a vehicle is detected by applying the present invention. Accordingly, there are proposed a method of detecting a vehicle and a method of checking whether or not there is a false detection among detection results.

In order to overcome processing delay occurring in the conventional Python-based Global Interpreter Lock (GIL) scheme that is shown in FIG. 2 and is a method of simultaneously processing multiple images, the present invention proposes a scheme in that image frames are fetched on a per-block basis, the fetched frames are segmented, similar adjacent frames are removed, and then a successive object detection method is applied, as shown in FIG. 3. FIG. 3(a) shows a conventional sequential image frame fetching and object detection method. In this method, all frames are sequentially fetched and processed, and thus it can be seen that similar images are repeated more than required. Accordingly, there is proposed a scheme in which image frames are fetched on a per-block basis, similar adjacent frames are removed from the fetched frames, the remaining frames are combined into a single image, and a successive object detection method configured to successively processing the images is applied, as shown in FIG. 3(b).

Furthermore, the proposed method enables a structure capable of simultaneously and successively detecting objects from a plurality of video images without delay by constructing a pool responsible only for detection, as shown in FIG. 4. In other words, in order to utilize a pool responsible only for detection, frames fetched from respective ones of multiple threads are passed to the pool, and multiple detectors present in the pool perform simultaneous processing.

Furthermore, the present invention provides an apparatus configured to receive an image stream from a conventional image storage server, to determine the types of objects via thee intelligent detection unit (an image analysis server), and to notify a client of the types of objects, as shown in FIG. 5. In this case, a plurality of cameras is connected to the single analysis server in order to simultaneously detect a plurality of objects, and a video image display unit is provided to display results of the analysis performed by the analysis server.

As in the proposed detection software structure of FIG. 6, the intelligent detection unit proposed in the present invention has a structure including the function of receiving and segmenting image frames and removing adjacent frames, the function of allocating unique IDs to detected objects, the function of storing detection results, and the function of detecting a plurality of objects via a pool responsible only for detection. The device configured to provide notification to the client has the function of including results of the detection of objects in an image stream received from cameras and transmitting them to a monitor, as shown in FIG. 7. In FIG. 7, the results of the objects detected from the video input stream via the intelligent detection unit can be found. In detail, FIG. 7(a) shows vehicle detection and counting, and FIG. 7(b) shows the types of injected products and error detection.

Next, step S200 of detecting objects from received images will be described in greater detail.

Detecting objects refers to the process of identifying objects of interest in cluster pixels and a video sequence. For this, methods such as frame differencing, optic flow, or background subtraction may be applied.

Next, step S300 of determining the types of objects based on results of the detection performed at step S200 will be described in greater detail below.

The objects may be each classified, for example, as a car, a bird, a cloud, a tree, or one of other moving objects. Methods of classifying such objects include shape-based classification, motion-based classification, color-based classification and texture-based classification, and may be individually applied according to detection target objects or the selection of a suitable method by a user.

Next, an object tracking method applicable to the present invention will be described in greater detail. Tracking may be viewed as an approximation of the path of an object on an image plane in a moving scene. In other words, it is determined whether or not a path along which an object of interest moves in a current image is similar to that of an object in a previous frame, and the former object continues to be tracked when it is determined that the two objects are the same. The object tracking method may include point tracking, kernel tracking, and silhouette tracking.

In order to perform object tracking, it is necessary to identify an object of interest in a video sequence. Furthermore, it also includes the process of clustering pixels. This process includes frame differencing, optic flow, and background subtraction. Frame differencing, optic flow, and background subtraction will be described in greater detail.

Frame differencing is a method of determining the presence of a moving object by calculating the difference between two successive images. A motion detection algorithm starts with a segmentation part in which a foreground or moving object is split in a background. The simplest way to implement this is to use an image as a background and compare a frame obtained at time t and denoted by l(t) with a background image denoted by B. Using the image subtraction technique of computer vision for each pixel of I(t), a pixel value denoted by P[I(t)] is taken, and then the value of a corresponding pixel located at the same location in the background image and denoted by P[B] is subtracted from the former pixel value. This is summarized as Equation 1 below:

P[F(t)]=P[I(t)]−P[B]

<Equation 1: An Equation for Calculating the Difference between Two Successive Images>

In this case, the background is assumed to be a frame at time t. The difference between images exhibits slight intensity only for pixel locations changed in the two frames. In this case, the background is apparently removed, but this method is applicable only to a case where all foreground pixels are moving and all background pixels are static.

Accordingly, in order to mitigate this point, a “threshold value” is applied to the difference between images, as shown in Equation 2 below.

|P[F(t)]−p[F(t+1)]|≤Threshold

<Equation 2: An Equation to which the Threshold Value is Applied>

In other words, since the difference between images eventually changes with time, an image is improved by performing calculation using the time variable t, removing the background, applying the threshold value to the foreground pixels, and performing subtraction. This is a desirable algorithm to apply to a case where there is an empty phenomenon.

Next, the optic flow will be described in greater detail.

The optic flow is the pattern representing the motion of edges, surfaces, and objects in a visual scene caused by the relative motion between an observer (an eye or camera) and the scene. The optic flow may illustrate a concept through a rotating observer in the case of floating in the sky. The direction and magnitude at each location are represented by the direction and length of each arrow. As shown in FIG. 8, much the direction and magnitude are affecting is indicated by the arrow on the surface. This may be simply viewed as a method of finding a motion vector in an image.

Next, the background subtraction will be described in greater detail.

A first step for the background subtraction is background modeling. The core of a background extraction algorithm is to fully recognize a moving object via background modeling. In the present invention, a mean filter and a median filter are recommended as a background modeling method. A method using the difference between a current image and a background image for the detection of a moving object is used as a background extraction method. This makes it possible to obtain complete information about an object if information about a background is known. A recursive algorithm and a non-recursive algorithm may be applied as the background extraction method.

Furthermore, there are a Gaussian of mixture model, an approximate median model, and an adaptive background model. The Gaussian of mixture model is a method of modeling the distribution of data using multiple Gaussian probability density functions. In an image, it refers to each pixel value (in the grayscale ranging from 0 to 255), and a background model is formed by learning a background. Using this, the background may be separately extracted. In order to separate the background and an object and detect the object more accurately in the process of learning the background, the process of applying a median filter is performed.

The present invention overcomes a bottleneck and delayed processing phenomenon attributable to GIL during the detection of objects, thereby providing an effect of rapidly detecting objects in real time without the bottleneck and delayed processing phenomenon.

Although the present invention has been described via the embodiments of the present invention with reference to the accompanying drawings, it will be apparent to those having ordinary skill in the art to which the present invention pertains that various applications and modifications may be made based on the foregoing description within the scope of the present invention.

What is claimed is:

1. A real-time object detection method for multiple camera images using frame segmentation and an intelligent detection pool, the real-time object detection method being an object detection method for detecting objects in real time from images photographed by a plurality of cameras via an intelligent machine vision apparatus, the real-time object detection method comprising:
a first step of receiving images from the cameras;
a second step of detecting objects from the received images;
a third step of determining types of objects based on results of the detection performed at the second step; and
a fourth step of displaying results of the types of objects determined at the third step.

2. The real-time object detection method of claim 1, further comprising, after the first step, a first additional step of fetching the received images as image frames on a per-block basis, segmenting the fetched frames, and removing similar adjacent frames.

3. The real-time object detection method of claim 2, further comprising, after the first additional step, a second additional step of successively detecting objects.

4. The real-time object detection method of claim 1, wherein the intelligent machine vision apparatus comprises an intelligent detection unit configured to receive images photographed by a plurality of cameras and to determine types of objects and a transmission unit configured to transmit results of the determination, performed by the intelligent detection unit, to a client.

5. The real-time object detection method of claim 1, wherein the intelligent machine vision apparatus comprises a function of removing adjacent frames after receiving and segmenting image frames, a function of allocating unique IDs to detected objects, a function of storing detection results, and a function of detecting a plurality of objects via a pool responsible only for detection.
